(19) United States
(12) Patent Application Publication
(10) Pub. No.: US 2021/0374874 A1
(43) Pub. Date: Dec. 2, 2021

(54) PLATFORM AS A SERVICE SERVING THE HEALTHCARE MARKETPLACE

(71) Applicant: MEDXOOM, INC., Atlanta, GA (US)

(72) Inventors: Shankha Basu, Marietta, GA (US); Jeffrey Toewe, Atlanta, GA (US)

(21) Appl. No.: 17/345,045

(22) Filed: Jun. 11, 2021

Related U.S. Application Data
(63) Continuation of application No. 16/695,991, filed on Nov. 26, 2019.
(60) Provisional application No. 62/771,233, filed on Nov. 26, 2018.

(51) Int. Cl. G06Q 40/08; G06Q 20/40; H04W 4/029; G06Q 30/04; G06Q 30/02

(52) U.S. Cl. CPC G06Q 40/08; G06Q 20/4016; G06Q 30/0204; G06Q 30/04; H04W 4/029

(57) ABSTRACT

A system for processing consumer and financial transactions related to past and future healthcare services and healthcare service searches or inquiries is claimed. The system generates a presenting a health plan member with options regarding fulfilling the healthcare service net due amount with applicable discounts and implements a decision scoring system for a platform for processing healthcare related transactions.

### CROSS-REFERENCE TO RELATED APPLICATION

This application is a continuation of provisional patent application Ser. No. 62/771,233, filed on Nov. 26, 2018, and pending utility patent application Ser. No. 16/695,991, filed on Nov. 26, 2019, the disclosures of which are fully incorporated by reference herein.

### BACKGROUND OF THE INVENTION

A system and method for improving healthcare financial and supply chain efficiencies and comprised of multiple components or ‘modules’ constituting a larger platform or ‘framework’. The modules are designed to work independently or together to improve accuracy of financial risk models for member (‘employee’, ‘patient’) coverage and coverage financing, develop transparent market healthcare service and product price points, streamline provider (physicians, practices, medical facilities, hospitals, durable good sales, and lab services among others) charge collections and member payments, and analyze and optimize healthcare supply chain efficiency for public and private insured groups.

Embodiments of the invention are expressed as independent modules which, when taken together as a whole, represent a platform as a service (“PaaS”)serving as a searchable healthcare market place, a medical services and products market adjusted pricing model, a risk based financial advice and finance products recommendations engine, and an optimized payments and related payment instruments framework integrated to the healthcare transactional claims stream and generally accessible as and/or an Application Program Interface (“API”) supporting the development of applications and/or distinct services related to:
a) the data pattern based discovery or definition and construct of packaged medical services or products, understood as medical procedure bundles representing partial, full, or continuous clinical treatment or episodes of care specific to a medically diagnosed condition or disease or as pharmacological prescriptions representing the control, containment, abatement, or cure of a medically diagnosed condition or disease, or subscription based services, here after “Baskets”; and where such discovered or defined and constructed Baskets are made available, listed or offered, here after “Market Listing”, to a plurality of health plans, employer groups, here after “Group” and their covered individuals, families, employees, and associated dependents, here after “Member”, and where such Groups and Members, and their representatives, assistants, or vendors such as but not limited to benefits administrator, concierge, or advocate, here after “Representatives”, in aggregate may be defined as “Consumer” within the context of a healthcare market place; and where the discovery or definition and construction of Baskets is driven by the analysis of Consumer sourced historical healthcare claims and transactions including but not limited to enrollment, eligibility, pre-certification, pre-authorization, remittance advice, here after “Claims Data”, and a plurality of related healthcare public and third-party sourced or licensed reference data sets and appends, here after “Market Data”; or optionally where a Basket may be created and priced ad-hoc expressly for a unique Member as a prescribed treatment; and/or alternately where such Baskets may be created through use of Hospital, clinic, practice, lab, provider, physician, imaging center, urgent care center, direct primary care, and other medical service vendors, here after “Healthcare Supplier”, sourced Claims Data and Market Data;
b) a searchable aggregated and/or third-party sourced and/or licensed data base of geo-located Healthcare Supplier service facilities and their listed, derived, or inferred service Baskets, made accessible to Consumers;
c) a unique point in time Health Supplier, their historical Baskets and associated medical outcomes, quality, known costs, and ascribed health benefit or adverse effect to a Group expressed as “Absolute Risk” and/or its impact to an individual Member expressed as “Relative Risk”;
d) a Consumer Claims Data and Market Data, and/or optionally Healthcare Supplier Claims Data, based, regionally adjusted, Basket pricing model;
e) intake, submission, or input and normalization of private enterprise or public government funded Group health plan and healthcare benefits design and policies data, here after “Coverage and Benefits” offered or available and subscribed or enrolled to by eligible Members;
f) a real time risk based, configurable weights, self-optimizing and evolutionary, recommendations engine generating Consumer financial advice and financing product recommendations; and where such a recommendations engine may be optimized through the aggregate of Group or Member Claims, Market Data, and individual or family demographics and financial and employment data, here after “Household Data”;
g) a payment instrument representing Group and Member Coverage and Benefits, Member financial purchase power, and a plurality of funds supporting single “in whole” payment and settlement of a healthcare bill or claim;
h) a currency conversion service;
i) potentially a real time or prompt pay automated financing, payment and settlement “in whole” of a unique healthcare Basket on behalf of a Group and/or Member based on Member Coverage and Benefits, risk recommendations engine output, and the known Healthcare Supplier Basket price or published Market Listing of such Basket; and
j) pre-service healthcare transactions driven group, advocate, concierge, managed care and/or member notifications inclusive of, but not limited to, healthcare service supplier outcome & cost risk, financial member/patient impact based on known group plan and member coverage and prescribed services and provider historical service charge or provider system registered bundle, procedure, product or service price points.

### SUMMARY OF THE INVENTION

A system and method for healthcare suppliers or providers (hospitals practices, ACOs, Direct Primary Care, labs, imaging, providers of medical services and products and other such medical entities) to store, manage, and in general list or publish medical “baskets” or bundles (consisting of procedures, services, supplies, and associated charges) to market consumers; namely healthcare groups and their healthcare members/beneficiaries. And further where such system and methods support the review, negotiation, contracting, purchase, payment, and financing, in general consumption, of medical bundles between suppliers and market consumers. This component may also optionally include the ability for the management and publication of medical supplier service bundles for market contracting, consumption, billing, and payments. Further details of this component can be found in the detailed disclosure contained hereinbelow and by reference to FIGS. 100, 200-A, 300, and 600-A, -B, and -C.

A system and method to validate health group member medical coverage, analyze and evaluate medical supplier's recommended bundles/services/products and pricing against known fair market price, assess supplier quality, capture early fraud risk signals, calculate health group or member financial risk and available health group or member funded payment and financing options, and subsequently generate and present recommendations of alternate or preferred lower cost & equal or higher quality service/product suppliers, and present payment methods and approved group and member financing in advance of medical service/product delivery. This component may also optionally include the ability for a user to engage in pre-purchase medical supplier comparison shopping, which will also allow a user to find alternate medical suppliers, calculate the optimal payment method for any necessary supplies and/or medications, and, if necessary, connect the user to a medical debt financing recommendation engine. Additionally, by capturing this data and information, the system is also able to uncover and notify persons and companies of indicators of medical billing and/or pricing fraud. Further details of this component can be found in the detailed disclosure contained hereinbelow and by reference to FIGS. 100, 200-A, 300, 600-A, -B, and -C, and 700.

A system and methods to enable a closed loop healthcare medical supplier bundles/services/products ‘cash’ or ‘full payment’ payments card comprised of medical coverage group plan service and benefits coverage, member identity and coverage plan profile, a closed loop payment authorization, fraud protection, and payments processing engine, a currency conversions engine, and an associated plurality of payment fund sources prioritized and governed by a healthcare payments & financing recommendations engine. This component may also optionally include a connection to a group and member price and fraud protection payments and/or debt financing card, device, or product. Further details of this component can be found in the detailed disclosure contained hereinbelow and by reference to FIGS. 100, 200-A and -B, 300, 600-A, -B, and -C, and 700.

A system and method to implement the collection, aggregation, identification, summation, tabulation, processing, and reporting of eligible purchased healthcare goods and services for purposes of an individual's tax benefit through deductions or in the re-imbursement of an individual's healthcare expenditures through tax exempt healthcare financial instruments. Further details of this component can be found in the disclosure contained in this provisional patent application.

Real time system and method to evaluate and buy a healthcare receivable based on risk factors associated with patient demographics, known employment history, current employment status, current salary, debt to income ration, and other risk correlated factors. Further details of this component can be found in the disclosure contained in this provisional patent application.

A composite fraud risk score assigned to a future claim or bill submission based on past healthcare events. Further details of this component can be found in the detailed disclosure contained hereinbelow and by reference to FIG. 700.

A method and process to advertise substitutable Rx drug for a given patient prescription with cost saving benefits to patient. Further details of this component can be found in the detailed disclosure contained hereinbelow and by reference to FIG. 800.

A unique payment ID representing a unified payment method comprised of one or more individual accounts, institutional payment sources, 3^{rd} party funding and/or loans. Further details of this component can be found in the disclosure contained in this provisional patent application.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown.

FIG. 10 is a schematic representation of a Healthcare Service Bundle.

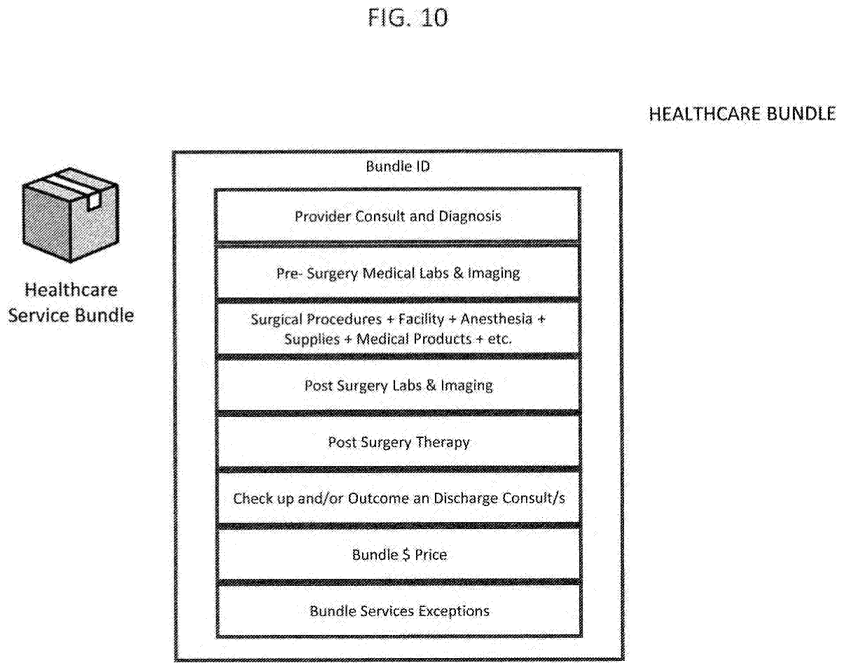

FIG. 20 is a schematic representation of a Healthcare Claim.

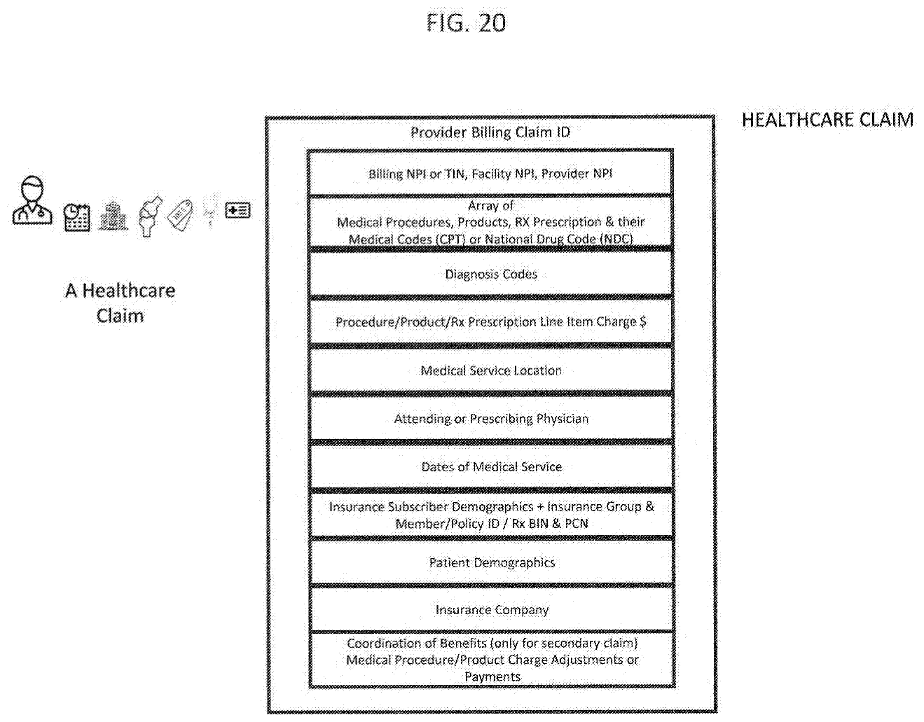

FIG. 30 is a schematic representation of a Health Plan Remittance.

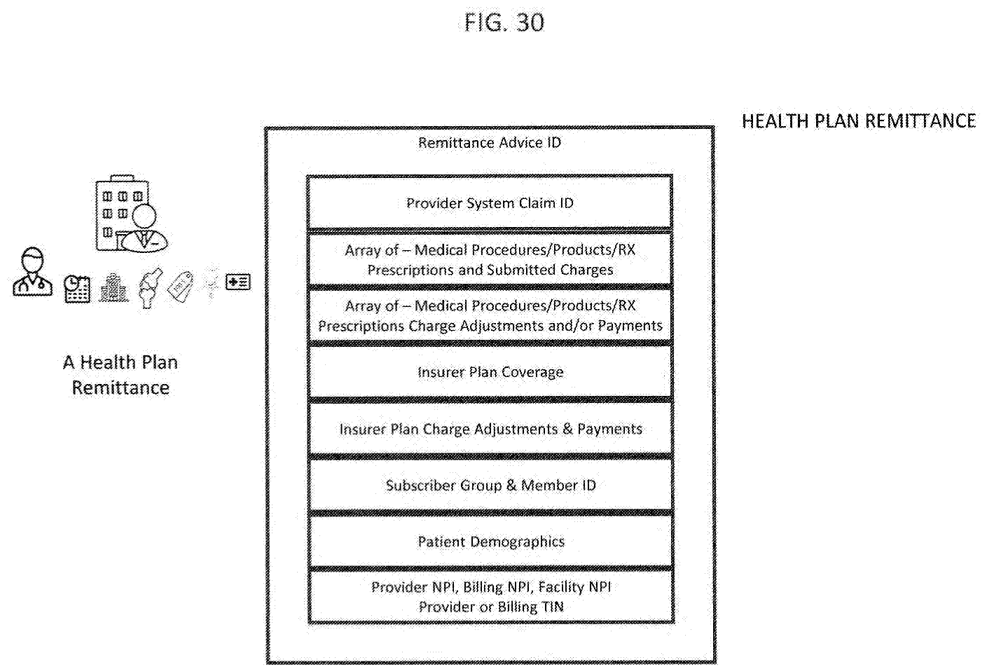

FIG. 40 is a schematic representation of a Health Plan Subscriber & Dependent Data.

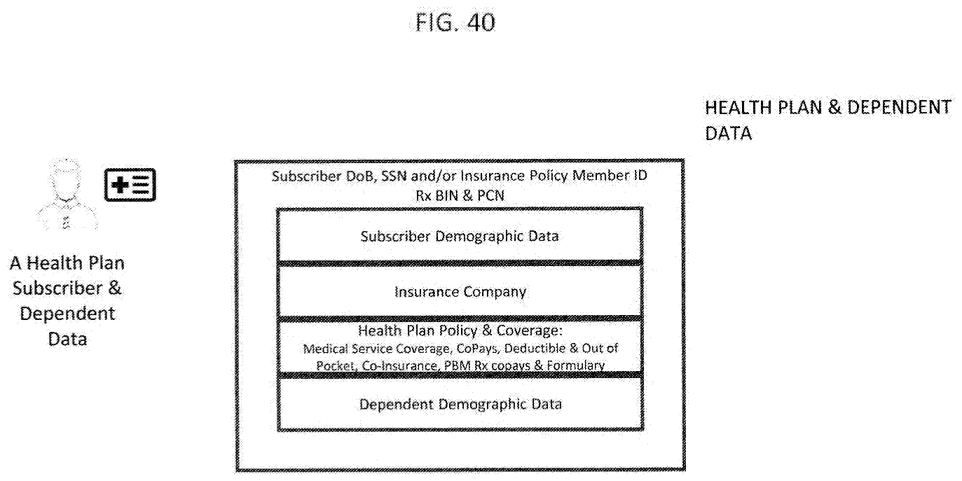

FIG. 50 is a User Composite Identity.

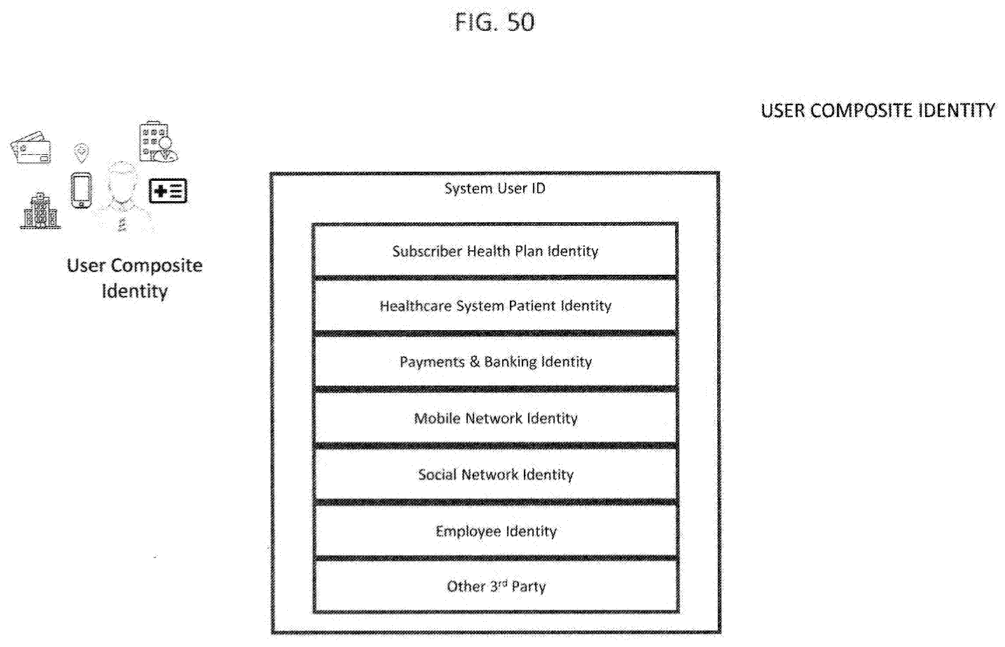

FIG. 100 is a schematic description of a portion of the invention.

FIG. 200-A is a schematic description of another portion of the invention.

FIG. 200-B is a schematic description of another portion of the invention.

FIG. 300 is a schematic description of another portion of the invention.

FIG. 400-A is a schematic description of another portion of the invention.

FIG. 400-B is a schematic description of another portion of the invention.

FIG. 500 is a schematic description of another portion of the invention.

FIG. 600-A is a schematic description of another portion of the invention.

FIG. 600-B is a schematic description of another portion of the invention.

FIG. 600-C is a schematic description of another portion of the invention.

FIG. 700 is a schematic description of another portion of the invention.

FIG. 800 is a schematic description of another portion of the invention.

FIG. 900 shows a schematic view of geofenced triggered actions as a portion of the invention.

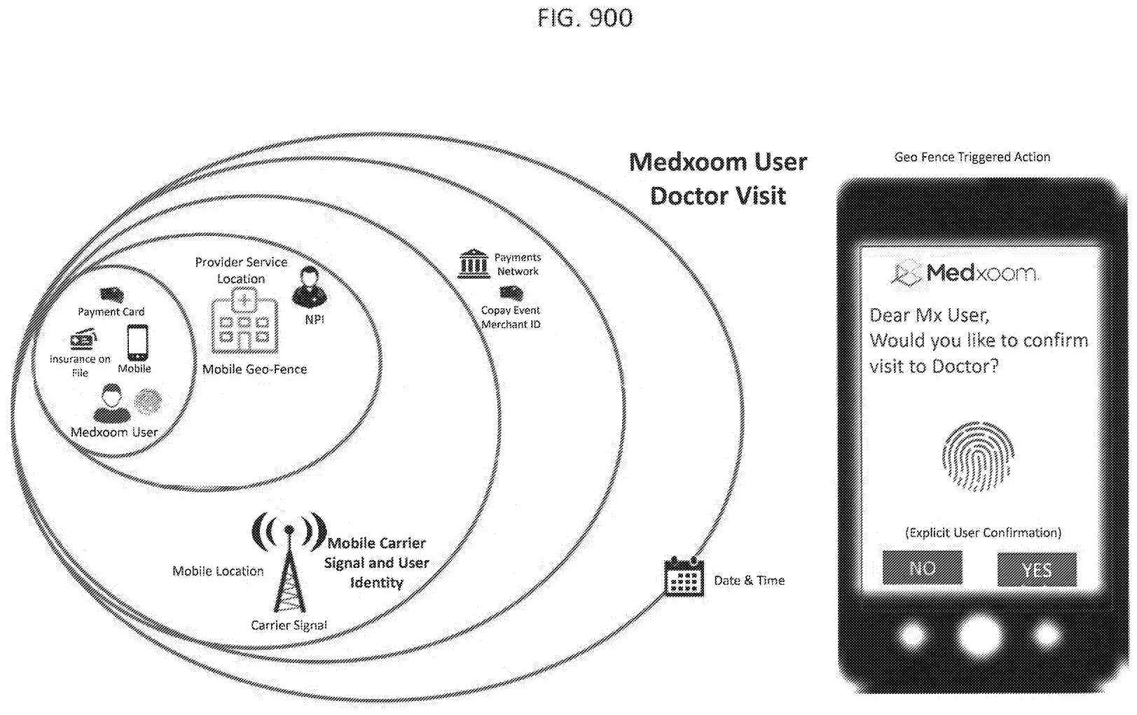

FIG. 1000 shows how the invention utilizes past Healthcare Supplier visits in relation to future claims and payments.

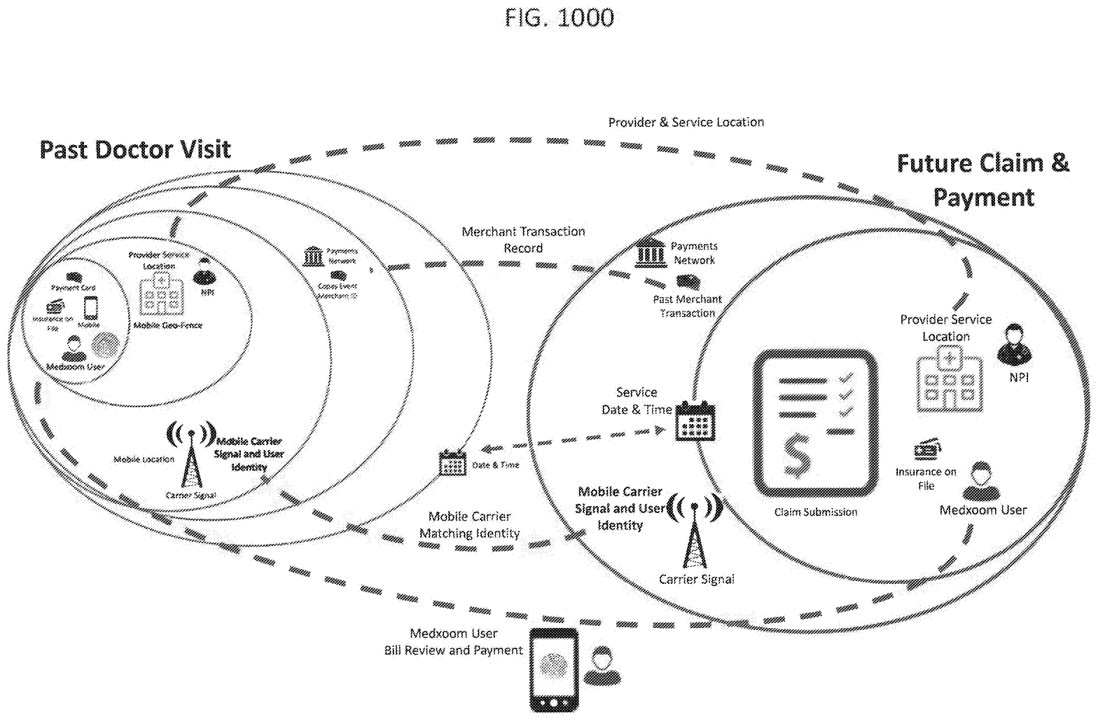

FIG. 1100 shows an example of the invention performing a calendar-drive Healthcare Supplier appointment and check-in.

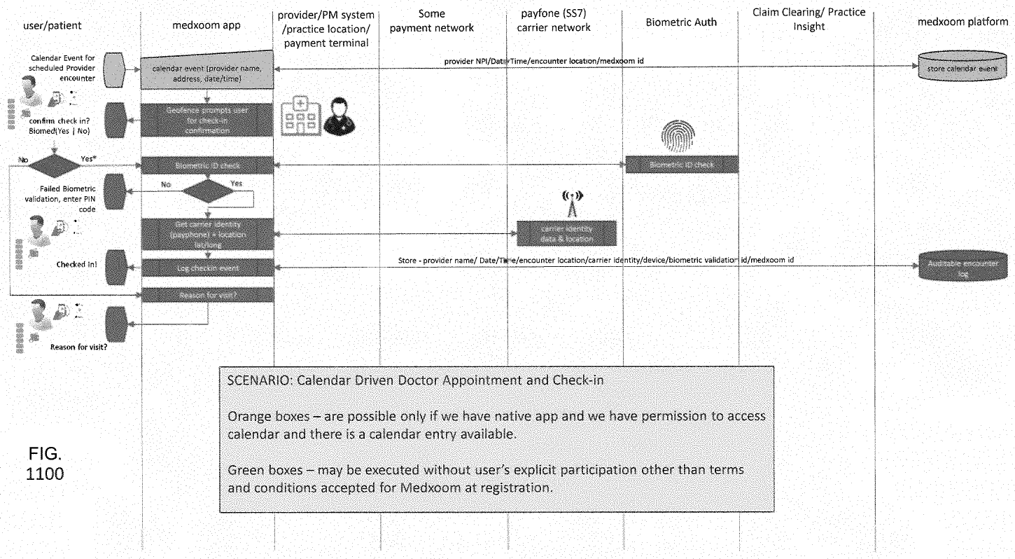

FIG. 1200 shows an example of the invention performing a geofenced check-in.

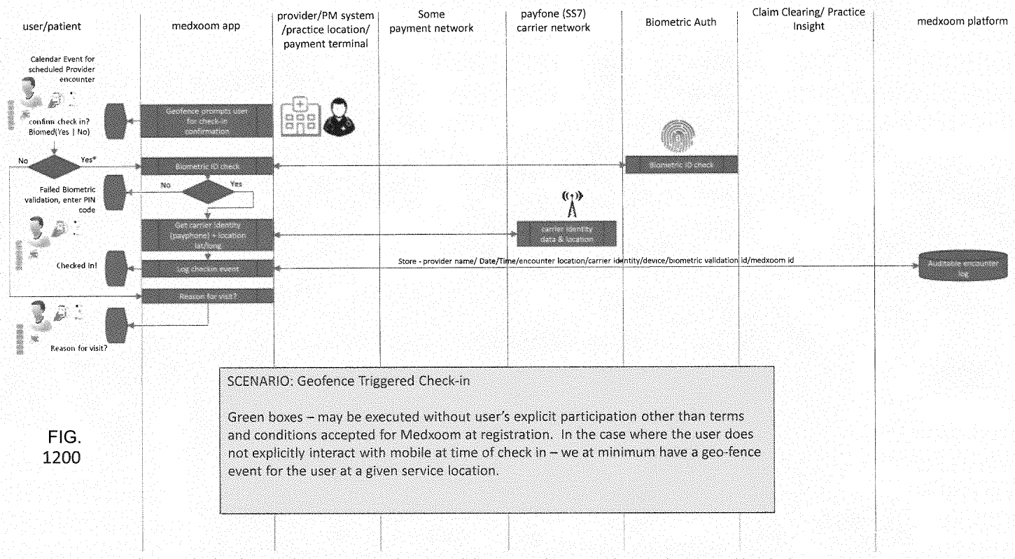

FIG. 1300 shows an example of the invention performing a merchant transaction driven check-in.

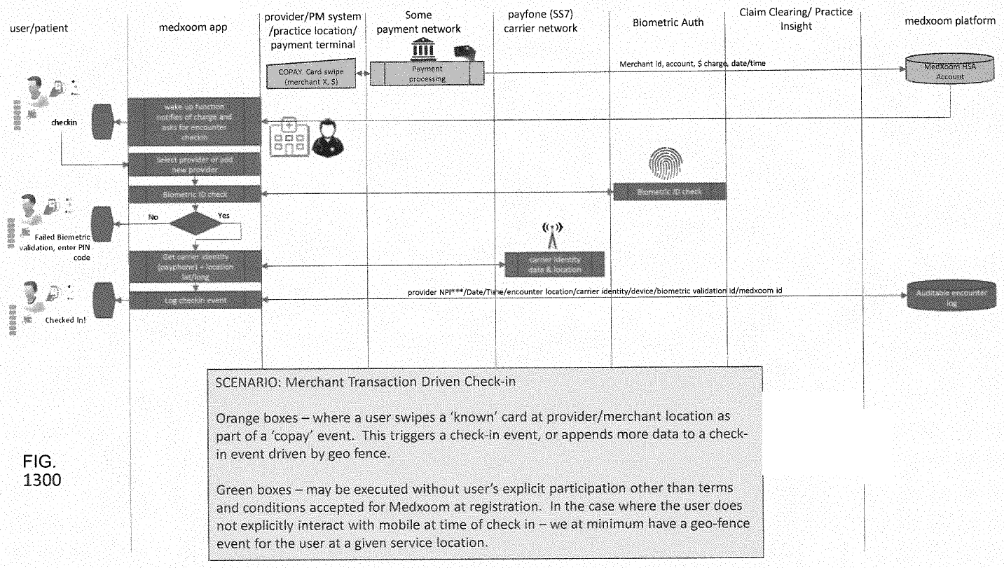

FIG. 1400 is a flowchart example of the invention utilized in a sample transaction.

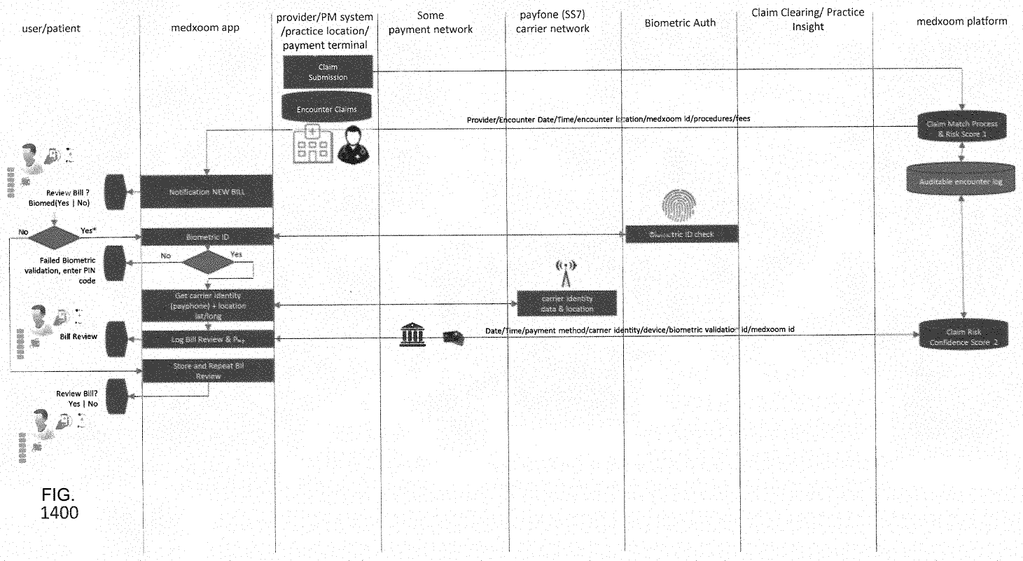

FIG. 1500 is a schematic diagram of a system and method in accordance with the present disclosure.

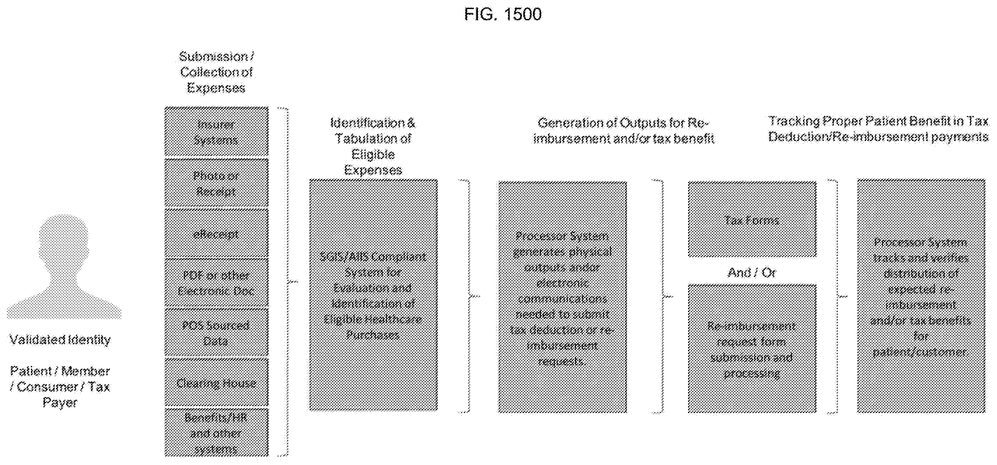

### DETAILED DESCRIPTION OF THE INVENTION

It will be appreciated by persons skilled in the art that the present invention is not limited to what has been particularly shown and described herein above. In addition, unless mention was made above to the contrary, it should be noted that the accompanying drawings are not to scale. A variety of modifications and variations are possible in light of the above teachings without departing from the scope and spirit of the invention.

### Detailed Descriptions of the Figures

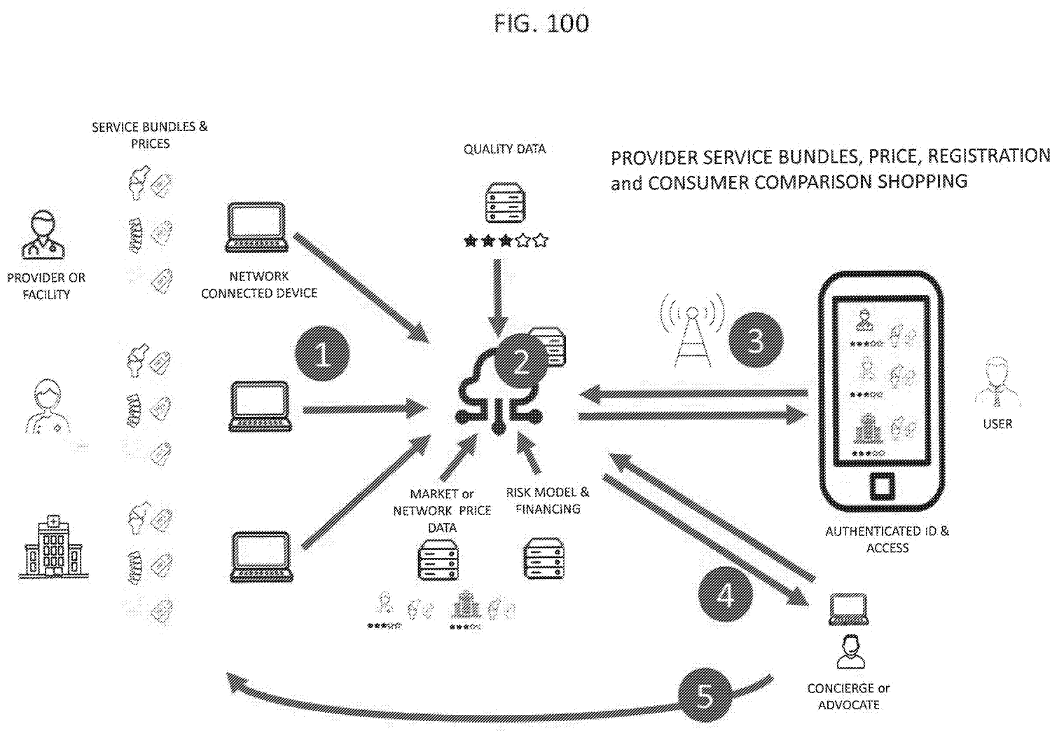

FIG. 100 shows how the system provides service bundles, price registration, and consumer comparison shopping components of the invention. With respect to FIG. 100, [1] shows that providers, hospitals, and/or medical facilities may register bundled price procedures through system portal or load batch file of bundled price services and providers into the system. As shown at [2], the system then analyzes the uploaded and/or input data for fraud, quality, and other factors (which are imported into the system from other databases or sources) and, if no fraud is detected, the data is then stored in the system database and scored using a proprietary method. Users may log-in to the system [3] and initiate searches or browse services, bundles, providers, and pricing. The user interface on the user's device displays a user interface (“UI”) that presents a stratified matching list of providers, products, services, and locations, along with financing and payment options, and, optionally, any incentives (such as rebates, cash value cards, and the like) which may be designed to steer the user towards a supply chain that is ‘friendly’ (i.e., price effective, presents rebates, discounts, is ‘in-network’, etc.) for the employer and/or insurer, all of the foregoing pulled from the system database for display to the user. The system also displays quality data, compares costs against market price data, analyzes financing risk, and offers payment plans and/or terms, and/or recommends financial options for the user. Finally, through [3] the user may secure, schedule, and/or pay for (whether directly, through a spending account, or through some payment or financing plan) the service. Optionally, as shown in [4] and [5], a user may optionally engage a concierge or consumer advocate through the system to complete the price comparison, financing, securing, and scheduling of an appointment and services.

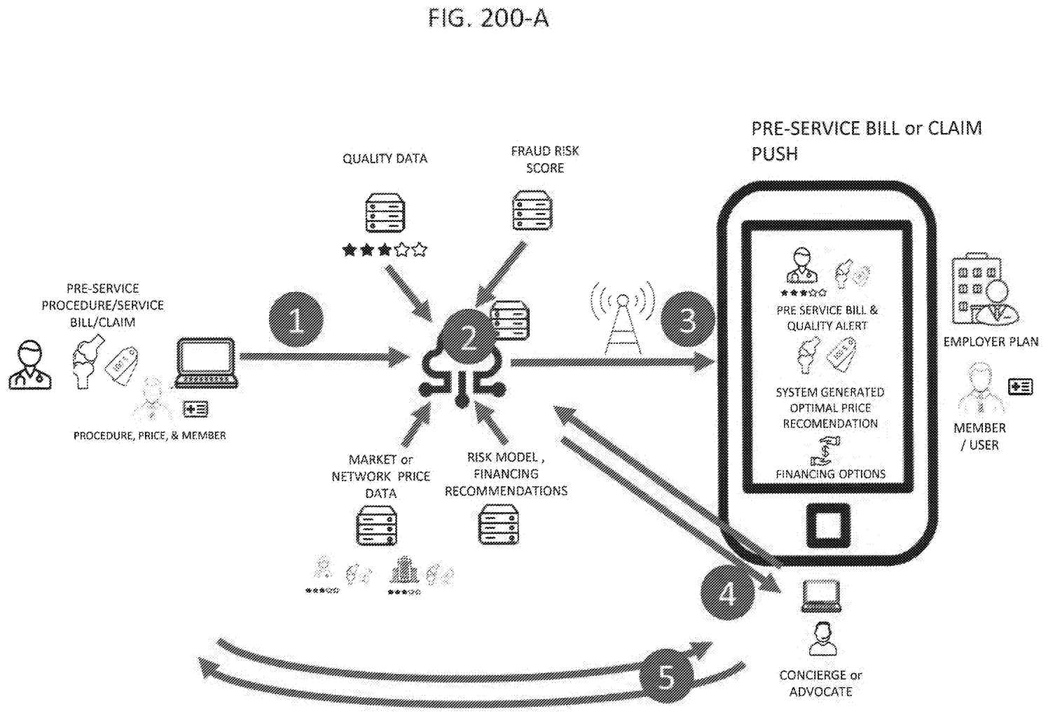

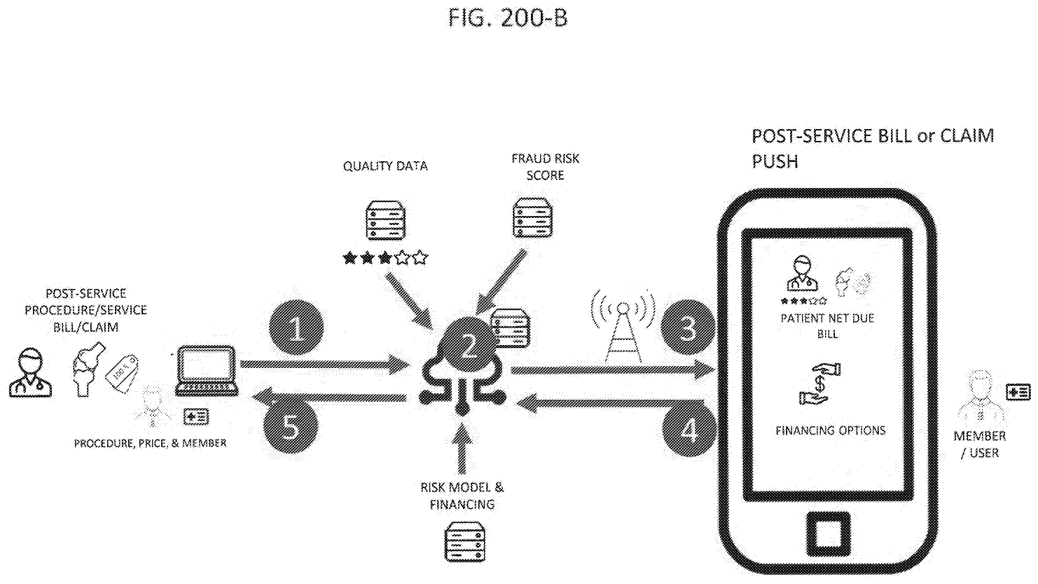

FIG. 200-A shows how the system provides pre-service billing and claim pushing functions. As shown in [1], a hospital, medical facility, or provider creates a procedure and/or service “Quick Bill” or basket comprised of any number of the following factors: member information, patient information, provider information, facility information, diagnosis information, procedure information, and price information, and submits it to system for delivery to plan and/or to member. The system [2] analyzes the information uploaded in [1] to analyze for fraud risk, and, if the information uploaded meets the system's minimum requirements, the information is accepted into the system, otherwise it is rejected. If accepted, the system stores the submitted bill and analyzes it for provider quality, price competitiveness (compared to network price data and price data collected from a variety of sources), financial risk of payment from the user, and, as appropriate, pre-approves the user for financing or other payment options. The system then [3] pushes a notification to the user providing details that include bill details, system appends and optimal price recommendation, along with financing and payment options, and optionally any incentives (rebate, cash value card, etc.) to steer user towards a supply chain that is ‘friendly’ (i.e., price effective, presents rebates, discounts, is ‘in-network’, etc.) for the employer and/or insurer. Optionally, as shown in [4] and [5], a user may optionally engage a concierge or consumer advocate through the system to complete the price comparison, financing, securing, and scheduling of an appointment and services.

FIG. 200-B shows further detail on how the system provides pre-service bill or claim pushes.

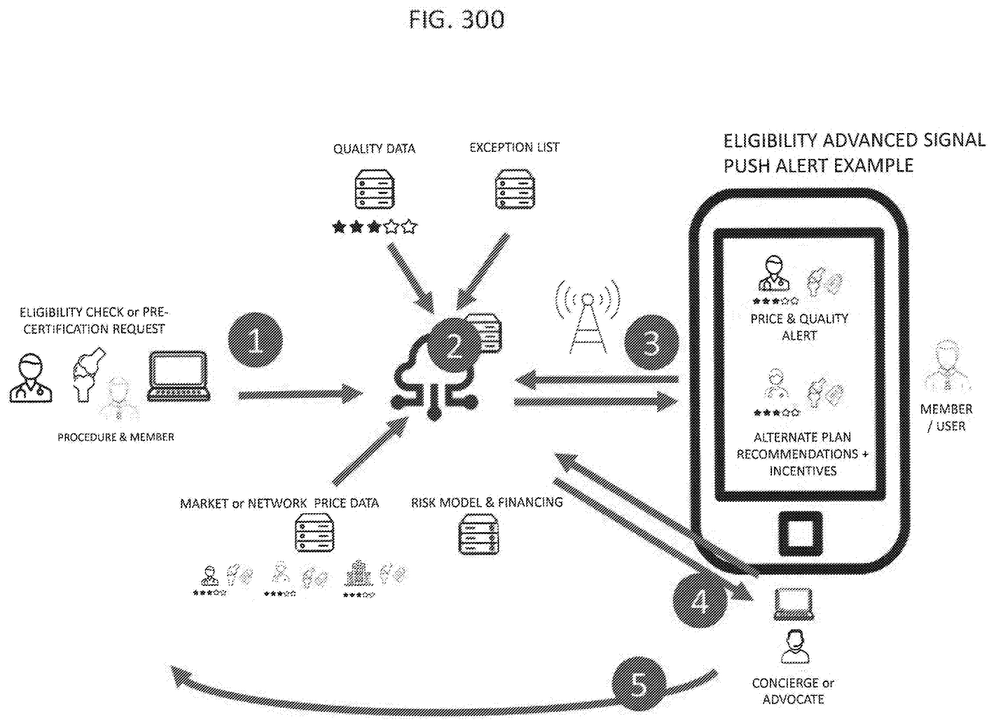

FIG. 300 shows how the system provides advanced signal push alerts. A provider [1] submits eligibility EDI 270 check, or pre-certification or referral EDI 278 request for service to the system. [2] The system identifies exceptions for alerts, analyzes for fraud risk and provider quality, generates provider price and out of pocket financial information for the user, compares this information to market or network price data, analyzes financial risk, and pre-approve for financing, if applicable. The system then [3] pushes a notification to the user which, following user authentication, provides details to the user including provider estimated price and out of pocket costs, system appended alternate provider recommendations with equal or better quality and lower cost basis, financing and payment options, any incentives (such as rebates, cash value cards, and the like) which may be designed to steer the user towards a supply chain that is ‘friendly’ (i.e., price effective, presents rebates, discounts, is ‘in-network’, etc.) for the employer and/or insurer, all of the foregoing pulled from the system database for display to the user. Optionally, as shown in [4] and [5], a user may optionally engage a concierge or consumer advocate through the system to complete the price comparison, financing, securing, and scheduling of an appointment and services.

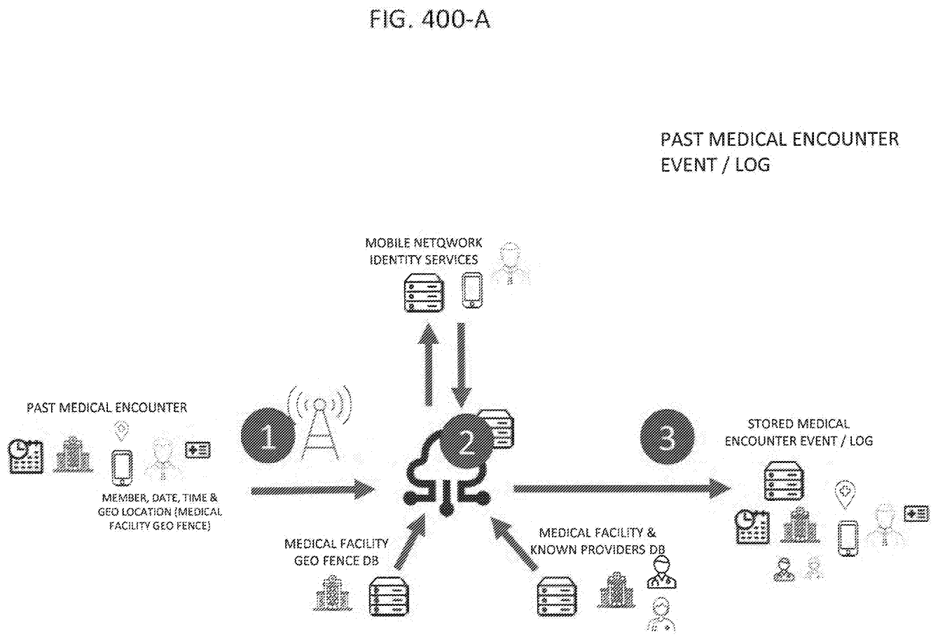

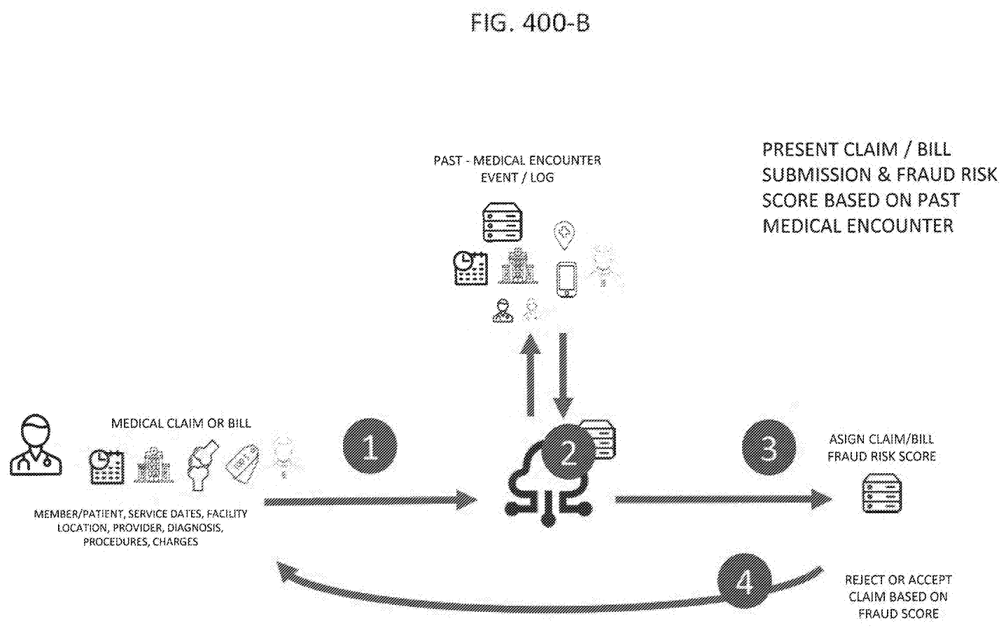

FIG. 400-A shows how the system provides a past medical encounter events log. When a user [1] visits a healthcare facility, the system records data through the user's mobile device signature either automatically or with explicit user interaction. The system [2] captures information about the visit, including date, time, medical facility geo-fence triggering boundary, and verified user identity. The system maps the geolocation of the user to a known medical facility and also maps the medical facility to known and/or associated providers. The system then [3] stores the event in its database.

FIG. 400-B shows how the system provides a bill submission and fraud risk score based on past medical encounters. [1] A provider or provider representative submits a medical claim to the system consisting of any number of the following: service dates, facility location, diagnosis and procedures, charges/fees, and member/patient information. The system [2] evaluates the medical claim data submitted against the past medical encounter event log for the patient (as shown being generated in FIG. 400-A). The system then [3] applies a fraud model and assigns a fraud risk score. Based on this fraud risk score the system then [4] either accepts or rejects the medical claim, or triggers other options, such as engaging the provider for issue resolution.

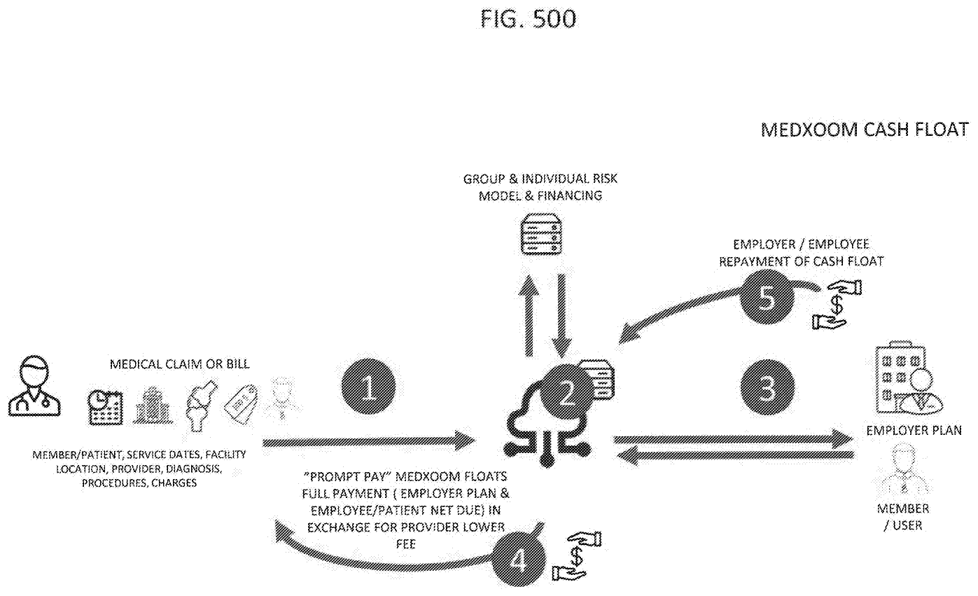

FIG. 500 shows how the system provides a cash float to users and medical providers. [1] A provider or provider representative submits a medical claim to the system consisting of any number of the following: service dates, facility location, diagnosis and procedures, charges/fees, and member/patient information. The system takes the submitted information and [2] applies group and individual repayment risk models to the submitted information. The system then notifies [3] the user and any designees (such as employers or plan administrators) of the pre-funding or approval event. Optionally, the user or any employer or plan administrator may be required to confirm explicit acceptance of funding and payment. Where employer approval is required for funding acceptance, system maybe automated through a set of thresholds that auto-approve funding amounts within specific claim MIN $ and MAX $ value range and/or a group level monthly MAX $. The system (or its partners) then [4] completes settlement of the claim or claims where in-payment account receivable is considered ‘prompt pay’, thereby netting a provider service discount, which may be split amongst the participating parties (the system, the plan, and/or the user). Finally, [5] the user or their designee initiate payment to fully repay the funded amount.

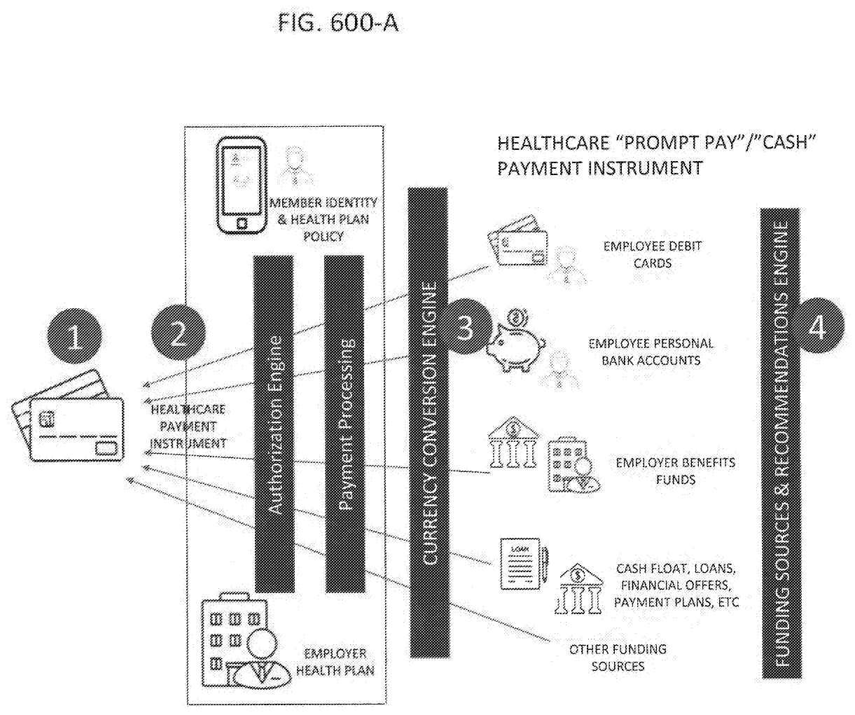

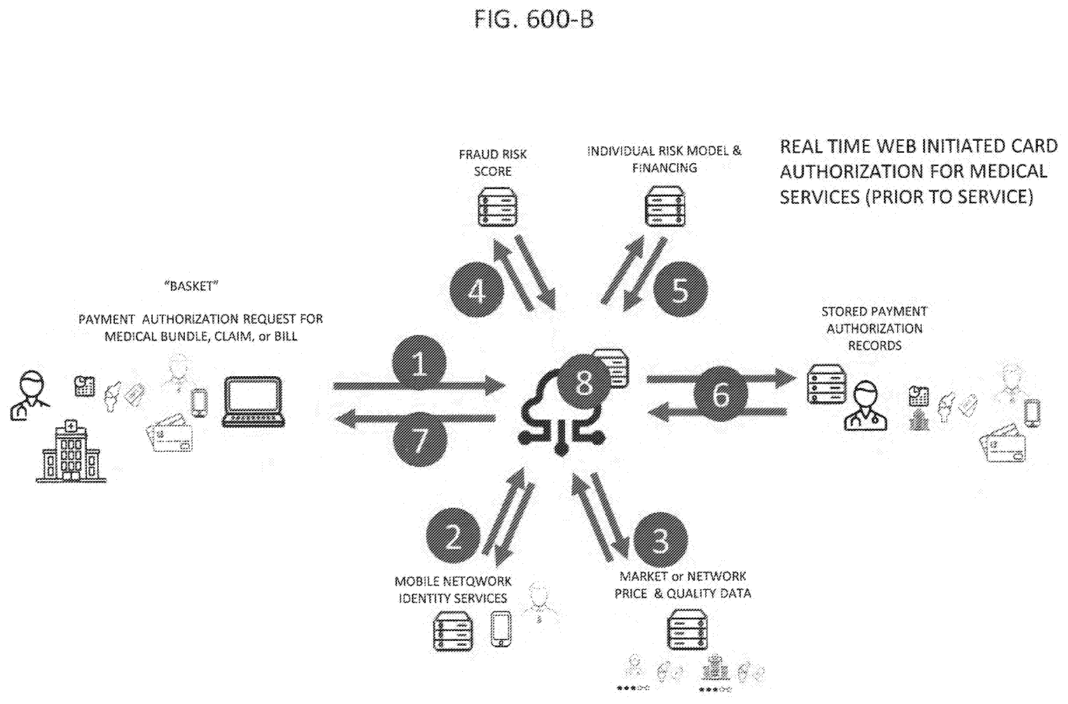

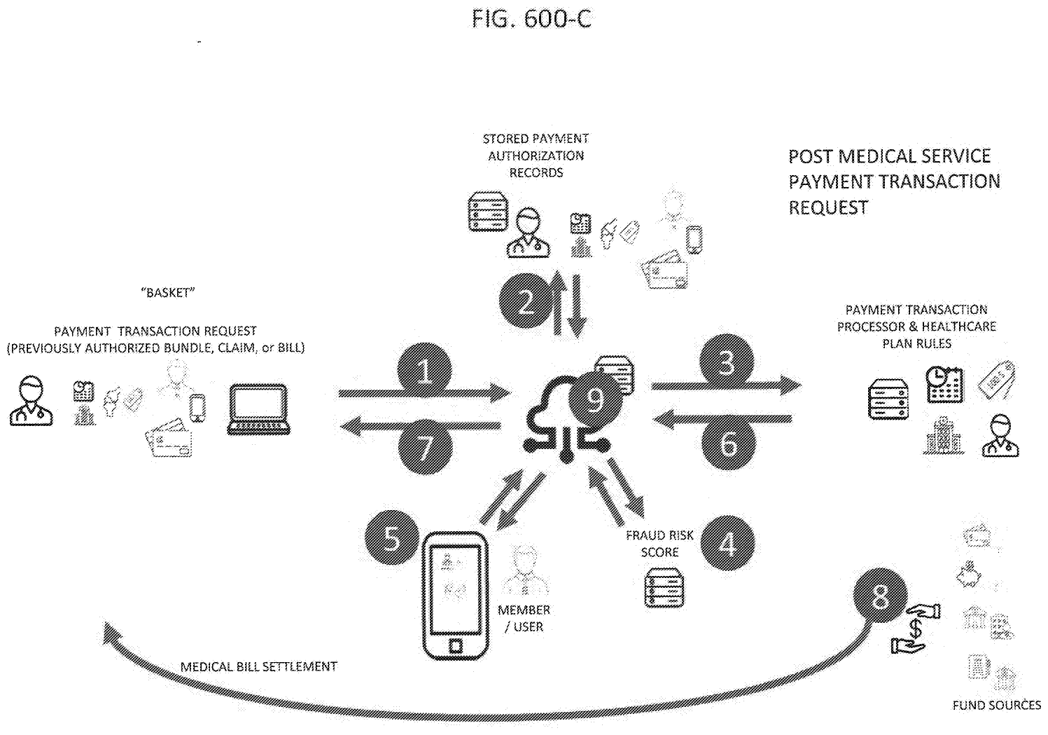

FIG. 600-A shows in greater detail how the system provides the prompt pay described above.

FIG. 600-B shows how the system provides a real time authorization for medical services, prior to providing the service. [1] Pre-service, a user presents Cash or Full Pay payment card. Hospital, ACO, HMO, Medical Facility, Provider, or Provider representative (a known payments network merchant) initiates a web based payment card pre-authorization request. The payment pre-authorization request consists of—future service date, payment card number, medical facility (known merchant), merchant category code, facility NPI, provider NPI, a previously registered medical service bundle id, medical bundle price (if any), and user identifier. [2] Where user mobile payment RFID or other near field method is utilized to validate and initialize payment pre-authorization, the proposed system will perform mobile network identity validation to improve fraud detection, where the aggregate of user authentication, mobile identity verification, merchant business and transaction history and identifier fraud signals are above pre-defined fraud score threshold payment pre-authorization request will be rejected. [3] Where bundle submission was not previously registered with system, submitted bundle and price are compared to market or network price. Where submitted bundle price is greater than the system defined price threshold, pre-authorization sum is limited to system generated optimal market price point. [4] The system applies fraud detection models, and where fraud risk above defined threshold, payment pre-authorization request is rejected. [5] The system applies financial risk models and pre-approves or declines financing offer for pre-payment of services. [6] Payment pre-authorization rejection, acceptance, acceptance with special conditions, or partial acceptance, and submitted basket details are recorded, stored, and a payment pre-authorization response sent to request originator. System rules will apply restrictions on when payment may be drawn, from which merchant (payment available for release/settlement only after the service scheduled date and a qualifying service event verification event, and potentially an explicit service outcome). [7] Provider web terminal displays rejection, approval, approval with special conditions, or partial approval of payment pre-authorization request, including rejection details or where authorization is accepted or partially accepted, the authorized amount, date and specific conditions for completion of payment transaction.

FIG. 600-C shows how the system provides a post medical service payment transaction request. [1] Post scheduled service date, Hospital, ACO, HMO, Medical Facility, Provider, or Provider representative (a known payments network merchant) initiates financial transaction for the previously authorized service basket; this includes the card number, authorization ID, the charge sum, merchant ID, and bundle ID. [2] The system accesses previously stored authorization record for processing. [3] Payment transaction processor evaluates payment transaction request against stored authorization record, healthcare plan rules, payment source ordinality, and/or employee configurable payment selection. [4] Fraud risk assessment evaluating payment transaction request signals inclusive of source merchant, payment source, member identity, among other elements. [5] Optionally, a user explicit payment validation may be added as part of an outcomes based overlay. [6] Payment is approved or decline and [7] that decision is communicated to the initial requestor.

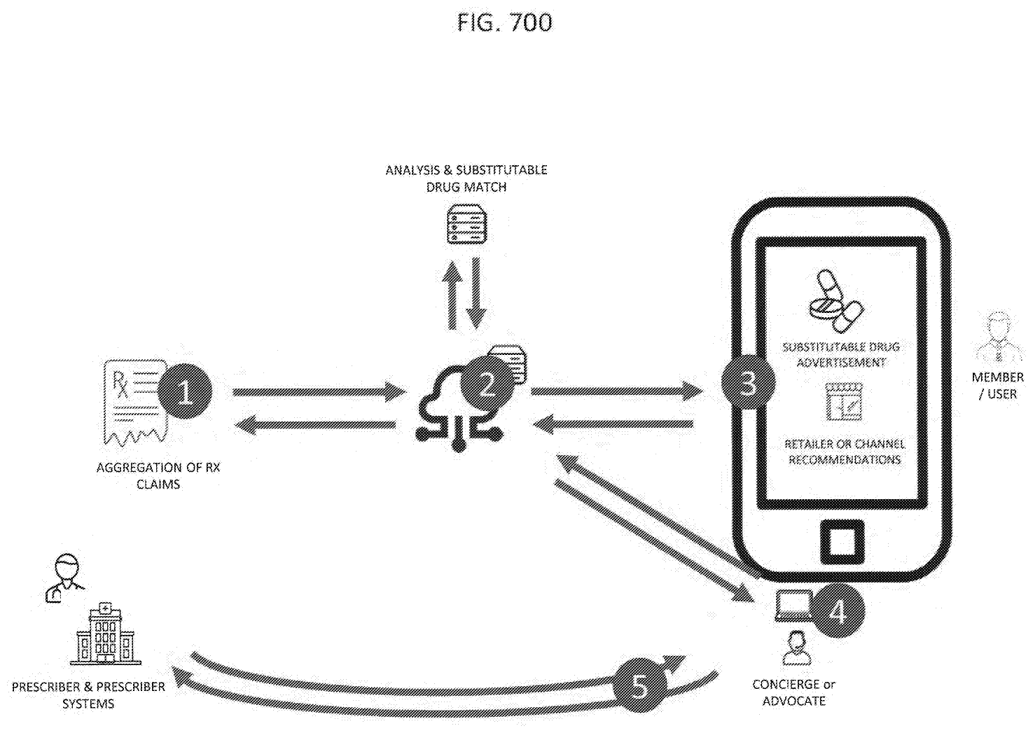

FIG. 700 shows how the system provides an analysis of prescribed drugs and substitute drug matching.

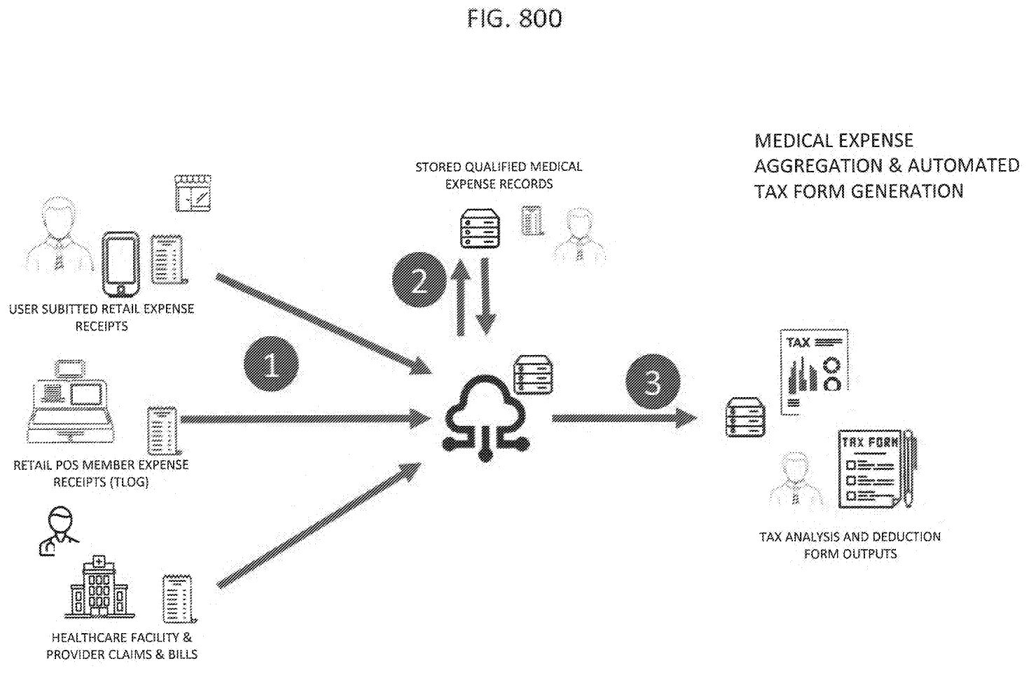

FIG. 800 shows how the system provides a medical expense aggregation and automated tax form generation.

### Detailed Descriptions of the Individual Components of the Invention

### 1. System and Method to Implement Collection, Etc. (Individual Component 1)

Historically, patients have themselves or through hired agents tracked healthcare expenses and manually evaluated their eligibility for tax benefit or reimbursement through available tax exempt healthcare financial instruments such as Flexible Spending Account (“FSA”)/Health Savings Account (“HSA”). Ultimately, the patient must then take data from disparate systems and source and utilize it (either themselves or through a hired professional or other expert) in their tax filings to receive any benefit from special tax status. This process is inefficient, labor intensive, error prone, and in-consistent in its identification of tax benefit qualifying healthcare related purchases/payments.

At present individuals or their named representatives expend excess labor/time to compile, record, collect, document, and track spend that may be eligible for tax deduction or eligible for tax exempt healthcare finance instruments such as FSA/HSA/HRA and the like.

The present invention streamlines the process of obtaining tax benefits or reimbursements from qualified healthcare costs by electronically aggregating, storing, and normalizing data from individual purchase/payment point of service, healthcare claims, and retail transaction streams including but not limited to: photos of purchase receipts; PDF or otherwise formatted invoice documents; eReceipts; and point-of-sale (“POS”), benefits and HR solutions and databases, clearing house claims networks, insurer systems, employer claims records, or third party administrator sourced data (claims, tlog, tlog extracts, database, or other POS data streams and the like).

Additionally, patients (either themselves or their representatives) expend excess labor/time to compile, record, collect, document, and track medical or healthcare spend that may be eligible for tax deduction or eligible for tax exempt healthcare finance instruments such as FSA/HSA/HRA and the like. The present invention automates the generation of tax deduction forms and/or reimbursement forms (as applicable) for an individual patient's eligible healthcare related expenditures and corresponding insurance and taxable income. The system captures contributions and expenditures associated with a patient's medical financial account (such as an FSA or HSA). This information is collected from a number of sources, such as from the patient or the patient's family, providers, medical claims clearinghouses, pharmacy benefits managers, third party administrators, insurance companies, and other payment and retail systems. Upon the end of a defined tax year the system automatically generates an electronic copy of IRS Form 8885, 8889, and 1040 among others with all required healthcare related fields populated.

Finally, patients (either themselves or their representatives) expend excess labor time manually or through fragmented systems to track/verify proper and accurate re-imbursement or returns on tax benefits. In some cases there is no validation or tracking present to insure patient/customer tax exempt benefits are met. The present invention solves this problem by tracking and validating healthcare spend reimbursements and tax benefit returns to ensure the best financial outcome for the patient.

Figure A, below, is a schematic diagram of the system and method.

The system and method consists of mobile, cloud, and transaction network-based solutions and processes to service tax exempt deductions or reimbursements of patient healthcare expenses.

### 2. Real Time System and Method to Evaluate and Buy a Healthcare Receivable

The real time system and method is comprised of five components:
a) a system supporting the registration of a plurality of re-usable medical claims or bundles and their associated services, peripheral services, equipment, herby “Baskets”, and an assigned publishable price or the submission of one off single use healthcare claim or bundle, herby “Basket”, and its associated price;
b) a provider system submitting a medical claim; and
c) an optional clearing house network;
d) a medical Basket consisting of patient data, covered member data, insurance data, attending physician data, dates of service, clinical diagnosis and submitted procedure and procedure modifiers, procedure charges, price, or fee, and potentially prior payer coordination of benefits or explanation of benefits (what the primary insurance did before it hands of to a secondary or tertiary payer).
e) a mobile device, network, and associated user account data and mobile utilization signals;
f) a user with registered profile, aggregate personal information and demographics data, and
g) associated multi factor authenticated mobile device.

A provider system generates a valid medical Basket and submits it to the system. The submitted Basket includes a known patient or member ID associated with a system registered user. The Basket total charges or price, after adjustments and payments from upstream payers where applicable, result in a known balance which is patient/member responsibility, which is part of the Basket that is submitted to the system. The patient responsibility charges in association with the covered member and patient, if they are the same, along with mobile network data inclusive of mobile subscriber socio economic data, identity, and demographics data, fraud risk score and any additional third party data appends which correlate to financial risk, are submitted to the system and result in an assigned financial risk score indicating whether the receivable (in other words, the patient responsibility) is high or low risk. Based on this result, the purchase and advanced settlement of that receivable, in exchange for an acceptable fee applied to provider payment, is calculated and results in a receivable note representing a collectible value from the member or the patient for the assumed debt.

### 3. A Composite Fraud Risk Score Assigned to a Future Claim or Bill Submission Based on Past Healthcare Events

A composite fraud risk score assigned to a future claim or bill submission based on past healthcare events has the following elements:
a) a system and mobile network authenticated user with a verified identity crosses a mobile geofence representing a known healthcare service facility or location;
b) such a geofence event triggers the measurement of the user's dwell time;
c) where the measured dwell time crosses a system defined threshold which subsequently triggers a database log entry denoting the known user's identity, the time/date, and the known healthcare service facility or location;
d) where a future healthcare claim received by the system is matched to the system registered user and where applicable to a known dependent or associated individual, and where such claim includes a healthcare service location, a date of service, an attending physician, a diagnosis, a list of procedures and associated charges;
e) to which the system applies a statistical risk model to the combined data representing the past recorded healthcare encounter with a submitted claim; and
f) where such model assigns a risk score which informs the system to accept the claim and proceed with processing of a bill for subsequent payment, or results in a rejected claim or a system alert to security personnel for further analysis and action.

### 4. A Method and Process to Advertise Substitutable Rx Drug for a Given Patient Prescription with Cost Saving Benefits to Patient

A system and method utilizing claims data for purposes of identifying unique user/member cost savings opportunities through use of therapeutically equivalent lower cost brand or generic substitutes and delivering advertising/marketing communications to inform the user of substitutable drugs and their potential costs savings has the following elements:
a) the system processes adjudicated healthcare group claims or other data signals which identify existing prescribed drugs of a system registered user;
b) the system process then analyzes the registered users identified prescribed drugs and evaluates for matching substitutable therapeutically equivalent drugs;
c) upon finding substitutable therapeutically equivalent drugs for the existing prescription such a system further analyses drug related price and cost data which allows for the calculation of potential savings, express as annual, monthly, or other basis;
d) in such cases where the matching substitutable drugs represent a lower prescription drug cost to the system registered user, a communication through known user communication channels is scheduled and triggered which delivers information regarding the substitutable drug and potential savings should user transition to the newly identified drug;
e) for individual users that are under the care of an affiliated health management or direct/primary care vendor, the system will automatically deliver a duplicate informational communication to authorized health management and direct/primary care personnel for purposes engaging the user/member to discuss substitutable drug options and their potential costs savings; and
f) subsequent to delivery of information to user/member and/or authorized healthcare management and/or direct/primary care personnel/vendor and prescribing physician and patient may discuss substitutable drugs and utilize other systems and methods to evaluate and decide whether or not to make adjustments to the user/member prescriptions.

### 5. A System and Method for Health Plan Covered Member/Beneficiary Healthcare Services Price Discovery, Health Plan Coverage Validation, and Pre-Services Healthcare Payments Submissions

Where a healthcare medical location, having an authorized copy of a beneficiary's health plan group and member identifiers and an electronic payer ID, initiates an electronic eligibility (EDI 270) or pre-authorization/Referral (EDI 278) inquiry, through a healthcare clearinghouse or directly, to a beneficiary's health plan.

And further where a system, representing or affiliated to the covered member/beneficiary's health plan, receives and processes such electronic eligibility or pre-authorization inquiries, or copy of such inquiries, generates a digital alert and delivers an informational and/or instructional digital packet to the health plan beneficiary relating to total expected procedure & services costs, the member's expected out of pocket spend, the inquiring provider quality signals as relates to a diagnosis and/or services, an ordered providers list by sorted lowest cost first and having with equal or higher quality score, plan preferred service providers and locations, acceptable plan rates for procedure, services, durable goods and available finance or payment options for specified or expected services.

### Detailed Description of Invention

A system representing or acting as a “payer” (commercial carrier or employer operating health insurance services or coverage for employees) supporting the submission of 270 ‘Eligibility’ requests and subsequent response from/to providers. A clearing house or claims routing entity: An external 3rd party clearing house routing ‘Eligibility’ requests and response from connected providers/physicians/healthcare facilities/institutions to/from a system representing a “payer”. A submitted ‘Eligibility’ request includes at least the following: healthcare service facility/location, originating physician/facility and NPI, and physician/service location/NPI associated taxonomy/ies, a covered member identity with an assigned membership ID, and a diagnosis code, is routed to a payer system through a clearing house network to a specified payer system for purposes of validating plan coverage and member status for provider services.

A healthcare provider or facility: A healthcare service facility/provider submitting Eligibility requests and receiving an Eligibility response from payer systems. The receiving payer system processes such an Eligibility request and matches the request member identity and/or member ID to a known or registered member. The payer system then extracts and identifies the physician/facility/NPI and associated taxonomy/ies within the eligibility request and searches stored or 3rd party data systems for historical or inferred medical services rendered by such a physician or facility. Next, the system searches its data stores or 3rd party data and locates healthcare services quality and outcome data associated such a physician/facility/NPI or institution. The diagnosis code/s found within the eligibility request is/are mapped to an allowable and commonly associated set of procedures/services/durable equipment, service bundles, and their known market prices and system defined price thresholds. The system then locates and extracts the member's known plan policy and coverage validating coverage of such services.

Once the system has aggregated information inclusive of physician/facility/institution, quality and outcomes, diagnosis and commonly associated procedure/services/durable equipment, it is then compared to system or 3rd party stored data of other physicians/facilities/NPI for the same diagnosis and associated procedures/services/durable equipment and their known or inferred prices. The system then prepares a communication to the member identified within the eligibility request which informs the member of: expected out of pocket spend, the inquiring provider quality signals as relates to a diagnosis and/or services, an ordered providers list by sorted lowest cost first and having with equal or higher quality score, plan preferred service providers and locations, acceptable plan rates for procedures/services/durable equipment, and available finance or payment options for specified or expected services. The system then pushes the information through known contact channels to alert member with financial and quality and outcome data, which allows the member to evaluate services rendered by the physician/facility/NPI originating the eligibility request against other physicians/facilities/NPIs which represent equal or better quality and outcomes at lower costs for same services.

### EXAMPLES

The present invention is further exemplified by the following examples:

### Example 1: Eligibility Absent a Diagnosis or CPT Code

Under this use case our proposed approach would be to leverage the provider taxonomy.

1. Receiving 270: Confirmed with clearinghouse partner that they can route 270 to us if we wanted to respond in real time. Clearing house has connectivity with multiple clearing houses including Change Health
2. Facility & Healthcare Supplier Identification: Within 270 payload we'll find and extract Service Provider Number, NPI, physician fname/lname and Facility Network Identification Number and address. Medxoom would will utilize these data attributes to find the matching provider on NPPES db or other reference provider database. Assume we will also have Mx Member ID which allows us to uniquely identify a registered Medxoom user.
3. Identify Taxonomies: Once we locate the facility and the provider on NPPES we would look up the taxonomies associated with a provider. We would leverage the physician's primary taxonomy to drive next steps.—where there is no primary taxonomy we would need to create a list of common procedures/services/durable equipment rendered at the facility by the physician.
4. Procedures: Now that we have a primary taxonomy we would look at common procedures/services/durable equipment associated with that taxonomy (assuming this is not a general practice/family physician and that they are a specialist).
5. Procedure Pricing: Having arrived at a ‘most common’ list of procedures/services/durable equipment for the taxonomy we could then append pricing data we have gathered or modeled and prepare a communication to the patient.
6. Informational Packet—Push Communication to Mx User: The communication would under this case be general in nature. “We have received a service eligibility inquiry from <practice name>, <Healthcare Supplier name>. Here is a list of common procedures/services/durable equipment rendered and your expected out of pocket for these procedures/services/durable equipment at this location. <insert an employer plan message here that communicates what the plan preferred providers/locations are if the present provider is not on the employer's preferred list of if the expected price is higher than what the plan would like to pay>. Each of the listed procedures/services/durable equipment could be a hyper link to additional detail of the procedure, things to know, and a more complete list of recommended providers and financial impact related information—including loan offer and potentially rebates or offer from the employer to seek alternate facility or provider.
7. Other Call to Actions: In addition to a general prices you should know communication we can include call to actions such as “Look up different procedure” and “Help me find lower my out of pocket”—which would lead user to experiences where they can price shop and locate physician.

### Example 2: Eligibility with Diagnosis & CPT Code

Under this use case our proposed approach would be to leverage the CPT codes to prepare an informational packet.

1. Receiving 270: Confirmed through Clearing House Partner or other clearing houses offering Eligibility 270/271
2. Facility & Healthcare Supplier Identification: Within 270 payload we'll find and extract Service Provider Number, physician fname/lname and Facility Network Identification Number and address. We would also extract the CPT code submitted in the payload. Assume we will also have Mx Member ID which allows us to uniquely identify a registered Medxoom user.
3. Procedure: Now that we have a procedure and provider, we would look up pricing related to both—fair procedure costs and what the provider typically charges for that same procedure. This data would then serve for OOP communication packet to Medxoom user.
4. Informational Packet—Push Communication to Mx User: The communication would under this case be CPT/diagnosis specific in nature. “We have received a service eligibility inquiry from <practice name>, <Healthcare Supplier name>. Here is expected price at this location and your expected out of pocket, plan recommended physicians with lower out of pocket. User could drill into detail about the procedure, things to know, and a more complete list of recommended providers and financial impact related information—including loan offer and potentially rebates or offer from the employer to seek alternate facility or provider.
5. Other Call to Actions: In addition to a general prices you should know communication we can include call to actions such as “Look up different procedure” and “Help me find lower my out of pocket”—which would lead user to experiences where they can price shop and locate physician.

### Example 3: Eligibility with Diagnosis Only

Under this use case our proposed approach would be to leverage the CPT codes to prepare an informational packet.

1. Receiving 270: Confirmed through Clearing House Partner or other clearing houses offering Eligibility 270/271
2. Facility & Healthcare Supplier Identification: Within 270 payload we'll find and extract Service Provider Number, physician fname/lname and Facility Network Identification Number and address. We would also extract the diagnosis code submitted in the payload. Assume we will also have Mx Member ID which allows us to uniquely identify a registered Medxoom user.
3. Diagnosis: Now that we have a Diagnosis and provider, we would look up diagnosis related most common procedures/services/durable equipment and what is typically charged for these procedures/services/durable equipment. This data would then serve for OOP communication packet to Medxoom user.
4. Informational Packet—Push Communication to Mx User: The communication would under this case be CPT/diagnosis specific in nature. “We have received a service eligibility inquiry from <practice name>, <Healthcare Supplier name>. Here is expected price more most common diagnosis and provider related procedures/services/durable equipment at this location and your expected out of pocket, plan recommended physicians with lower out of pocket. User could drill into detail about the procedures/services/durable equipment, things to know, and a more complete list of recommended providers and financial impact related information—including loan offer and potentially rebates or offer from the employer to seek alternate facility or provider.
5. Where provider recommended procedure does not match most common procedure list, patient is invited to see other diagnosis associated procedures/services/durable equipment or initiate a procedure search of their own.

What is claimed is:

1. A method for processing consumer and financial transactions related to future healthcare services comprising:
receiving an eligibility request;
identifying a member, a healthcare service provider and diagnosis data from the eligibility request; and
responsive to identifying the member, the healthcare service provider and the diagnosis data:
aggregating historical medical services data rendered by the healthcare service provider, wherein the historical medical services data comprises outcome and quality data associated the healthcare service provider, and determining a quality score of the health service provider;
mapping a commonly associated set of services and prices from the healthcare service provider based on the diagnosis code;
validating coverage of the commonly associated set of services to a policy associated with the member;
determining an expected out of pocket spend, acceptable plan rates and available payment options based on the commonly associated set of services and prices and the policy associated with the member; and
automatically generating a communication to the member with the expected out of pocket spend, the quality score of the health service provider, the acceptable plan rates, and the available payment options.

2. The method of claim 1, wherein the eligibility request comprises the healthcare service facility and location, an originating physician, facility and NPI and associated taxonomies, a covered member identity of the member with an assigned membership ID, and a diagnosis code.

3. The method of claim 1, wherein the outcome and quality data associated the healthcare service provider correspond to the diagnosis data.

4. The method of claim 1, wherein the commonly associated set of services comprise procedures, services, durable equipment, and service bundles.

5. The method of claim 1, wherein the method further comprises:
aggregating historical medical services data rendered by other healthcare service providers, wherein the historical medical services data comprises outcome and quality data associated with each of the other healthcare service providers, and determining a quality score of each of the other healthcare service providers;
mapping a commonly associated set of services and prices from the other healthcare service providers based on the diagnosis code;
validating coverage of the commonly associated set of services from the other healthcare service providers to a policy associated with the member;
determining an expected out of pocket spend, acceptable plan rates and available payment options based on the commonly associated set of services and prices of the commonly associated set of services from the other healthcare service providers and the policy associated with the member; and
comparing the historical medical services data, the quality score, the mapped commonly associated set of services and prices, the expected out of pocket spend, the acceptable plan rates of the healthcare service provider with that of the other healthcare services;
wherein the automatically generated communication further comprises an ordered providers list by sorted lowest cost with equal or higher quality score and plan preferred service providers.

6. The method of claim 1, wherein the available payment options include financing options.

7. A data processing system configured for processing consumer and financial transactions related to future healthcare services, the system comprising:
a host computing system comprising one or more computers each with memory and at least one processor;
an application executing in memory of the host computing system; and,
a module coupled to the application, the module comprising program code enabled to receive an eligibility request; to identify a member, a healthcare service provider and diagnosis data from the eligibility request; to respond to identifying the member, the healthcare service provider and the diagnosis data by aggregating historical medical services data rendered by the healthcare service provider, wherein the historical medical services data comprises outcome and quality data associated the healthcare service provider, and determining a quality score of the health service provider; by mapping a commonly associated set of services and prices from the healthcare service provider based on the diagnosis code; by validating coverage of the commonly associated set of services to a policy associated with the member; by determining an expected out of pocket spend, acceptable plan rates and available payment options based on the commonly associated set of services and prices and the policy associated with the member; and by automatically generating a communication to the member with the expected out of pocket spend, the quality score of the health service provider, the acceptable plan rates, and the available payment options.

8. The system of claim 7, wherein the eligibility request comprises the healthcare service facility and location, an originating physician, facility and NPI and associated taxonomies, a covered member identity of the member with an assigned membership ID, and a diagnosis code.

9. The system of claim 7, wherein the outcome and quality data associated the healthcare service provider correspond to the diagnosis data.

10. The system of claim 7, wherein the commonly associated set of services comprise procedures, services, durable equipment, and service bundles.

11. The system of claim 7, wherein the module comprising program code is further enabled to aggregate historical medical services data rendered by other healthcare service providers, wherein the historical medical services data comprises outcome and quality data associated with each of the other healthcare service providers, and determining a quality score of each of the other healthcare service providers; map a commonly associated set of services and prices from the other healthcare service providers based on the diagnosis code; validate coverage of the commonly associated set of services from the other healthcare service providers to a policy associated with the member; determine an expected out of pocket spend, acceptable plan rates and available payment options based on the commonly associated set of services and prices of the commonly associated set of services from the other healthcare service providers and the policy associated with the member; compare the historical medical services data, the quality score, the mapped commonly associated set of services and prices, the expected out of pocket spend, the acceptable plan rates of the healthcare service provider with that of the other healthcare services; and wherein the automatically generated communication further comprises an ordered providers list by sorted lowest cost with equal or higher quality score and plan preferred service providers.

12. The system of claim 7, wherein the available payment options include financing options.

13. A computer program product for processing consumer and financial transactions related to future healthcare services, the computer program product comprising a non-transitory computer readable storage medium having program instructions embodied therewith, the program instructions executable by a device to cause the device to perform a method comprising:
receiving an eligibility request;
identifying a member, a healthcare service provider and diagnosis data from the eligibility request; and
responsive to identifying the member, the healthcare service provider and the diagnosis data:
aggregating historical medical services data rendered by the healthcare service provider, wherein the historical medical services data comprises outcome and quality data associated the healthcare service provider, and determining a quality score of the health service provider;
mapping a commonly associated set of services and prices from the healthcare service provider based on the diagnosis code;
validating coverage of the commonly associated set of services to a policy associated with the member;
determining an expected out of pocket spend, acceptable plan rates and available payment options based on the commonly associated set of services and prices and the policy associated with the member; and
automatically generating a communication to the member with the expected out of pocket spend, the quality score of the health service provider, the acceptable plan rates, and the available payment options.

14. The computer program product of claim 13, wherein the eligibility request comprises the healthcare service facility and location, an originating physician, facility and NPI and associated taxonomies, a covered member identity of the member with an assigned membership ID, and a diagnosis code.

15. The computer program product of claim 13, wherein the outcome and quality data associated the healthcare service provider correspond to the diagnosis data.

16. The computer program product of claim 13, wherein the commonly associated set of services comprise procedures, services, durable equipment, and service bundles.

17. The computer program product of claim 13, wherein the method further comprises:
aggregating historical medical services data rendered by other healthcare service providers, wherein the historical medical services data comprises outcome and quality data associated with each of the other healthcare service providers, and determining a quality score of each of the other healthcare service providers;
mapping a commonly associated set of services and prices from the other healthcare service providers based on the diagnosis code;
validating coverage of the commonly associated set of services from the other healthcare service providers to a policy associated with the member;
determining an expected out of pocket spend, acceptable plan rates and available payment options based on the commonly associated set of services and prices of the commonly associated set of services from the other healthcare service providers and the policy associated with the member; and
comparing the historical medical services data, the quality score, the mapped commonly associated set of services and prices, the expected out of pocket spend, the acceptable plan rates of the healthcare service provider with that of the other healthcare services;
wherein the automatically generated communication further comprises an ordered providers list by sorted lowest cost with equal or higher quality score and plan preferred service providers.

18. The computer program product of claim 13, wherein the available payment options include financing options.
